(19) United States
(12) Patent Application Publication
(10) Pub. No.: US 2006/0199599 A1
(43) Pub. Date: Sep. 7, 2006

(54) METHOD FOR SETTING COMMUNICATION DEVICE AND COMMUNICATION DEVICE THEREOF

(76) Inventors: Arun Gupta, Faridabad (IN); Vikram Salwan, New Delhi (IN)

Correspondence Address: NORTH AMERICA INTELLECTUAL PROPERTY CORPORATION, P.O. BOX 506, MERRIFIELD, VA, 22116, US

(21) Appl. No.: 11/306,494

(22) Filed: Dec. 29, 2005

Related U.S. Application Data
(60) Provisional application No. 60/641,100, filed on Jan. 3, 2005.

(30) Foreign Application Priority Data
Sep. 13, 2005 (IN) 2476/DEL/2005

(51) Int. Cl. H04Q 7/20

(52) U.S. Cl. 455/466

(57) ABSTRACT

A method for adding a user interface setting to a communications device is disclosed. The method includes receiving a message including the user interface setting from a messaging service; extracting the user interface setting from the received message; and storing the extracted user interface setting in the communications receiver. In addition, a communications apparatus has a receiver module for receiving messages under a message service protocol like SMS; a parsing module for detecting whether one or more of the received messages contains an identifier indicating that the at least one message containing setting data; and a processor module for providing a user interface according to the setting data.

### CROSS REFERENCE TO RELATED APPLICATIONS

This application claims the priority benefit of U.S. provisional application No. 60/641,100, which was filed on Jan. 3, 2005 and is included herein by reference.

### BACKGROUND

The present invention relates to a method for configuring a user interface of a communication apparatus, and more particularly, to a method for configuring a user interface of a communication device over a communication network.

Devices such as mobile telephones contain an interface by which the user interacts with the device. This is commonly called the man-machine interface (MMI) or simply, the user interface (UI).

Communication devices have a host of user interface (UI) attributes. When these attributes are considered in a group, they can be referred to as a theme. Examples of communication devices include a mobile phone, a PDA, or various computer devices that can be connected to a network. The mobile phone makes a good example for describing the UI that offers configurable attributes because there are often many UI attributes available and many preset themes available for the user to enjoy. The theme describes what is often called the “look and feel” of the UI. Specifically, the theme is the collections of UI features (i.e., attributes) that provide the basis whereby interaction with the user is transacted. Usually these are considered the visual and audible features, however, vibration feedback is another example of a UI attribute. In short, if a function of the device causes stimulation to any of the usual human senses of the end user then it can be considered part of the device's

Obviously any particular theme is dependent on the given features provided by the mobile device. For example, based on the capabilities of a typical mobile device, the theme might be responsible for controlling colors, images, tones, and even the device's skin. Please note that skin is a term commonly used to refer particularly to the entire UI's appearance, for example, a color scheme. A theme will supercede a skin, in that the theme can comprise a skin's appearance features as well as more elaborate UI attributes such as on screen button locations, audible feedback, and so on. A change from one theme, having one skin, to a different theme, having a different skin, can result in a completely different look and feel of the entire UI of the mobile device. In other words, a change in the theme of the mobile device is capable of changing any or all of the attributes of the UI layout.

Today, users may download themes to their mobile devices if these mobile devices can be connected to a data network, e.g. GPRS network. For example, if the mobile device is a cellular phone that supports GPRS, the cellular phone may provide WAP or TCP/IP stacks for performing downloading operation from a web site. The web site can be WAP or HTTP compliant that is designed to facilitate the downloading of themes for the mobile device. In this way, the end user is able to download themes thereby changing the look and feel of their mobile phone as often as they wish. It is important for the user to have the capability of changing themes since a new theme will cause the mobile phone to seem different and new thereby making it more enjoyable for the user and satisfying the user's desire to see and hear new UI settings. Alternatively, users can apply a USB or IR interface for downloading themes from a connected computer.

Unfortunately, not all mobile devices, and in particular cellular phones, support these connectivity methods. It is not convenient to connect a mobile phone to a computer for editing or changing its themes. This is especially true for low-end devices where the consumer is making a purchasing choice based on a very low cost of the mobile phone. Moreover, in cases when technologies like WAP, TCP/IP, USB, IR, or other similar means are available for theme downloads these technologies are not always easily utilized. For instance, theme downloads can be inconvenient or impossible in many situations, such as: when the service provider does not support GPRS connectivity, while traveling, when access to the user's personal laptop or computer is not available, or when USB cables or IR peripherals are forgotten.

Therefore, it is useful and convenient to find new methods for downloading themes to communication devices, such as cellular phones. It is important that new methods for theme downloads overcome the problems of the prior art as described earlier.

### SUMMARY

According to an embodiment of the invention, a method for obtaining user interface settings of a communication device includes the following steps. Messages are received at the communication devices under a message service protocol like simple message service (SMS) channel over a communication network like a GSM telecommunication network. If a received message does not contain a predetermined identifier that indicates the received message containing setting data, the received message is processed under a normal processing procedure, e.g. displaying text information on the communication device. Otherwise, one or more received messages that contain the identifier are parsed for obtaining setting data in the message bodies used for configuring user interface of the communication device. If the setting data are carried by multiple messages, the setting data are further combined to form one user interface setting, e.g. theme configuration data, of the communication device. The user interface setting can also be stored as just one option for controlling user interface of the communication device.

According to another embodiment of the invention, a method for transmitting user interface setting includes following steps. Theme or other user interface settings are packaging into messages under a message service protocol like SMS channel. The message service protocol is originally designed for transmitting text information. However, an identifier is put in messages that carry setting data so that such messages can be found and parsed for obtaining theme or user interface configuration. Then, such messages carrying setting data are transmitted over a communication network like a GSM telecommunication network to a communication device.

According to another embodiment of the invention, a communication apparatus includes a receiver module, a parsing module and a processor module. The receiver module is used for receiving messages under a message service protocol like SMS channel. The parsing module checks each received message to find whether there is any message carrying a predetermined identifier indicating that the message containing setting data. If a message does not carry setting data, it is dispatched for normal processing procedure, e.g. displaying associated text on the communication apparatus. Otherwise, setting data are parsed out and form user interface settings of the communication apparatus so that the processor module can provide a user interface according to the user interface settings. The receiver module, the parsing module and the processor module refer to corresponding hardware, firmware, software and/or their combination. Today, there are various approaches to design a communication device like a mobile phone, and person skilled in the art can implement the above mentioned functions into their practical products without undue experiments. For example, in a mobile phone system, there are program codes that process SMS messages. Function codes can be written to check whether each incoming SMS message contains an identifier, e.g. a predetermined header. If the incoming SMS message does not contain such identifier, the SMS message is passed to a traditional SMS processing function for displaying text information on the display of the mobile phone. Otherwise, the incoming SMS message is parsed for obtaining setting data stored therein for constructing necessary theme configurations of the mobile phone.

With the invention, even low-end communication devices can support capability of changing themes. However, it is noted that the above descriptions are used as examples instead of limitations to the scope of the invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is simplified block diagram of a communication device that can obtain a user interface setting over a communication network.

FIG. 2 is a software aspect of the communication device of FIG. 1.

FIG. 3 is a flowchart illustrating SMS message processing as an exemplary example of the present invention.

FIG. 4 is a diagram illustrating a combination of a communication apparatus as an embodiment according to the present invention.

FIG. 5 is a diagram illustrating the theme download/upload scheme according to an embodiment of the present invention.

### DETAILED DESCRIPTION

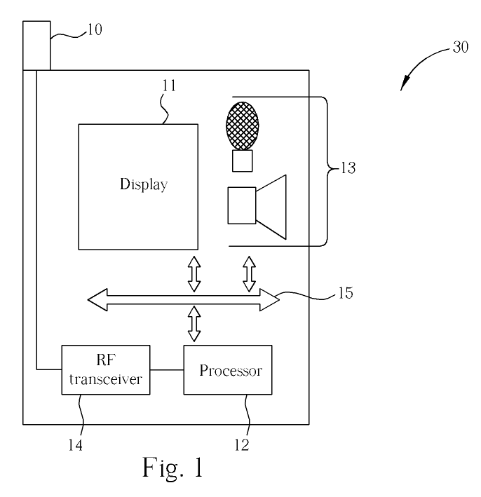

FIG. 1 illustrates an exemplary mobile phone hardware architecture, which is an exemplary type of a communication device and is capable of obtaining a user interface setting over a communication network. The mobile phone has an antenna 10, a RF transceiver 14, a processor 12, an IO bus 15, a display 11, and an audio device 13, which includes a microphone and a speaker. Messages and audio data are received from the antenna 10 and forwarded to the RF transceiver 14. The processor 12 executes program codes stored in its internal memory or an external memory like a flash or a ROM for decoding messages from the transceiver 14. The processor 12 also provides a set of user interface by showing images on the display 11 and playing sounds from the audio device 13 via the IO bus 15. The interface setting may include text color, button type, ring tones, etc. Usually, one set of interface setting is named as a theme that includes visual settings and/or audio setting. In practice, persons skilled in the art may change this basic architecture to various designs. For example, the display 11 may be a color liquid crystal display. The processor 12 and the RF transceiver 14 can be incorporated into a single chip or divided into several chips connected together. Programs executed by the processor 12 can be replaced as corresponding combination logic or firmware.

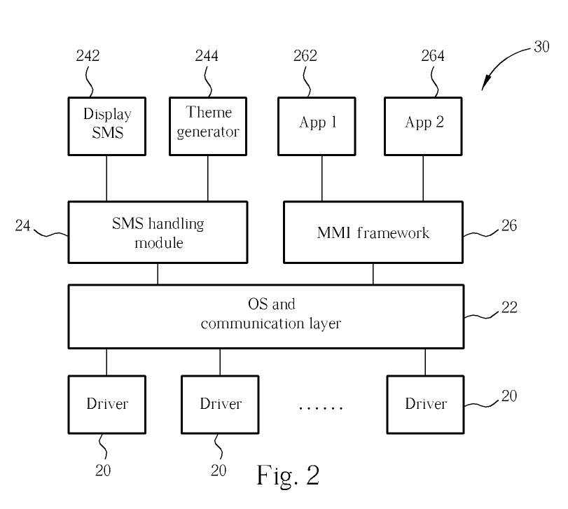

FIG. 2 illustrates an exemplary software aspect of the mobile phone in FIG. 1. An operating system with functions of communication layers 22 is provided as a backbone of the mobile phone. A plurality of drivers 20 are installed so that the OS and communication layers 22 can communicate with corresponding hardware devices, like the display 11 and the audio device 13 as illustrated in FIG. 1. A Short Message Service (SMS) handling module 24 is used for processing SMS messages from the OS and communication layers 22. Persons skilled in the art know that SMS is a message service protocol designed for transmitting text messages to be displayed on a mobile phone display over GSM or other networks. Moreover, since SMS is stipulated in GSM standard, every mobile phone under GSM standard, even with least features, still supports SMS capability. In other words, even low-end phones that lack support of GPRS, TCP/IP, EMS, USB or IR can be used in implementing the present invention. It is also noted that other message protocols originally designed for transmitting simple text information, e.g. unstructured supplementary service date (USSD) can be applied in such example under certain arrangement and adjustment.

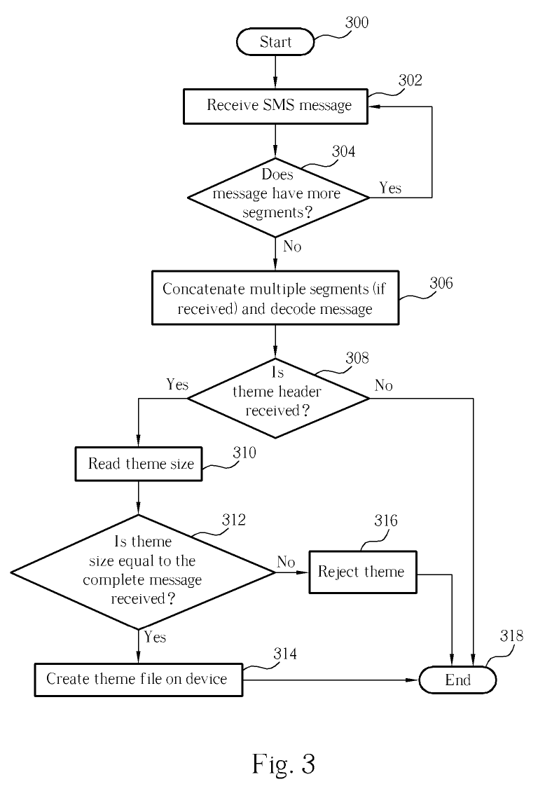

FIG. 3 illustrates a flowchart illustrating an exemplary processing logic when the SMS handling module 24 receives a SMS message from the OS and communication layers 22. Following GSM specification, persons skilled in the art know how to implement communication layers for parsing and obtaining SMS messages from a GSM network and here these details are omitted. When a SMS message is received, the SMS handling module 24 is triggered (step 300, step 302). The SMS handling module 24 checks whether the SMS message has other segments related to the SMS message (step 304). If there are other segments related to the SMS message, it waits to receive all segments. Otherwise, the SMS handling module 24 concatenates multiple segments and decodes the received data (step 306).

Then, the SMS handling module 24 checks whether one or more received SMS messages contains a predetermined identifier like a predetermined header portion (step 308). An example of such header portion looks as follows.

<Theme Identifier><Theme Size><Delimiter>

where,

<Theme Identifier>=Title of the theme

<Theme Size>:=XXXX (where XXX is the theme size in bytes)

<Delimiter>:=Space

This sample theme header is provided by way of example and not as a limitation to the present invention. The message format for the downloadable theme is highly extensible based on the characteristics of the communications device. Based on the size of a particular theme, the message may have a plurality of segments, that is, the message is transmitted via multiple SMS message segments. If this case, a message header of the received message is detected and by inspection of the message header will determine the number of segments thereafter concatenating data of the user interface setting transmitted via segments of the received message. For example, the parameter <Theme Size> indicating the theme size can offer the required information of the number of SMS message segments to be processed. If a theme header is received (step 308), a theme size is to be read (step 310). If the theme size equals to the complete message received (step 312), a theme file is created (step 314) according to the setting data stored in the received SMS message. Otherwise, the theme is rejected (step 316). The end (step 318) of the flowchart may be directed to a normal procedure, e.g. displaying text messages on a display if the SMS message received does not contain setting data.

By parsing the first line of the message format shown above, it can be determined if the SMS message containing this text appears to be a theme header (i.e., comprises “<Theme Identifier>”, etc.) or is a non-theme header (i.e., a regular SMS message indented for reading by the user of the mobile device). If the SMS handling module 24 finds that the received message does not contain user interface setting data, the SMS message is forwarded a normal processing procedure, e.g. showing the SMS message on a display, as illustrated as the functional block 242 in FIG. 2. Otherwise, the SMS message is processed by a theme generator 244 that parses setting data inside one or more SMS message and creates corresponding user interface settings. The message format is highly extensible and is limited only by the device capabilities. The message format can be extended so that the theme includes more “look and feel” attributes such as, but not limited to: changing the color of any on screen control object (e.g., buttons, menus), changing wall paper and screen saver images, adding or changing tones and other audible feedback elements, changing the on screen coordinate location of control objects (e.g., buttons, menus, pop-ups), changing display fonts, adjusting the font size, menu fonts, and changing the size of control objects (e.g., increasing the size of an onscreen button). The feature of extensibility easily increases to include whatever new theme capabilities are included with newly released communication devices.

Additionally, the message format can be modified as needed to accommodate the various and different ways that manufacturers implement their themes. For example, the theme can be defined as comprising many pieces of theme data. The theme data can then be stored in a data structure within the mobile phone. The present invention functions regardless of how the vendor or manufacturer stores themes within the data structure. In fact, as themes are supplemented (e.g., with the release of new devices) the theme data structure may necessarily change. Adapting the present invention to a change of this type involves a modification of the message format for the downloadable theme as described earlier. No other modifications are needed. The modification of the message format obeys the spirit of the present invention.

Now referring back to FIG. 2, when a theme data is created and stored in the mobile phone, associated theme configuration can be used for providing a corresponding user interface using the MMI framework 26. For example, when applications 262, 264 display a selection list on the display of the mobile phone, the MMI framework renders the selection list according to current user interface setting, e.g. the created theme data.

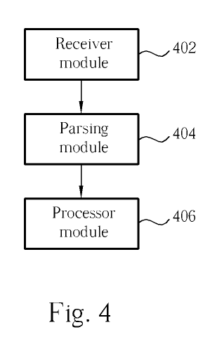

With the above mentioned embodiment and corresponding variation designs, a communication device that supports SMS protocol can obtain a theme configuration from a communication network once the communication device supports SMS protocol. Since such communication device can be designed in various approaches, it is summarized to include a receiver module 402, a parsing module 404 and a processor 406 as illustrated in FIG. 4. The receiver module 402 is used for receiving messages like SMS messages. The parsing module 404 is used for detecting among received messages whether there is at least one message containing a predetermined identifier, e.g. the header portion described above. If a received message does not contain the predetermined identifier, the received message is forwarded to a normal processing procedure, e.g. displaying text information on a display. Otherwise, the received message is parsed to obtain setting data so that the processor module 406 provides a user interface according to the setting data.

The receiver module 402, the parsing module 404 and the processor module 406 can be hardware, software, firmware or their combination. Persons skilled in the art can implement such modules under different demands by referencing to the exemplary example illustrated and described in FIGS. 1, 2 and 3.

In addition to the communication device that can obtain a user interface setting over a communication network, the invention covers the aspect of a method of transmitting user interface setting to the communication device. The method includes packaging setting data like theme configuration into one or more SMS messages and transmitting such SMS messages to communication devices that support SMS messages. Under practice, the method can be performed by a telecommunication operator using its network server. Alternatively, the method can be implemented in an electronic device that can creates and sends SMS messages to another mobile phone that can obtain user interface setting via parsing SMS messages. The electronic device can be a mobile phone or a computer. In real application, a user can even transmit a copy of the theme configuration of his/her phone to anther via SMS message channel as mentioned above.

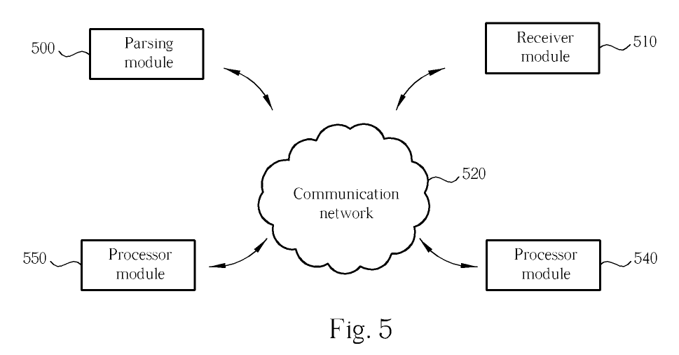

Please refer to FIG. 5. FIG. 5 is a diagram illustrating the theme download/upload scheme according to an embodiment of the present invention. As shown in FIG. 5, a computer 500, a web server 550 hosting a web site, and a plurality of mobile phones 510, 540 are coupled to a communications network 520. In this embodiment, the mobile phone 510 is a destination device for theme download, while the computer 500, the web server 550 and the mobile phone 540 are source devices for theme upload. The details of are omitted since the operation of these devices is well known. Additionally, the components related to the present invention are described in FIG. 1's communication device and those same components must be present in the mobile phone 510. In the embodiment, a theme is received and transmitted using SMS messages. The messages are the same as those described in earlier figures. The computer 500 and mobile phone 510 can be any device that supports the SMS standard. The communications network 520 includes a messaging service such as what is provided by a cellular telecommunications provider and an Internet link. Additionally, a web server 550 supporting messaging service provides a web site interface for users of the computer 500 or the mobile phone 540 to upload (transmit) a theme for storage on the web server 550 or user of the mobile phone 510 to download (receive) a theme from the web server 550. In addition, with the help of the communications network, the user of the computer 500 can directly send a theme to the user of the mobile phone 510 by sending the theme via an SMS message. Similarly, a user of mobile phone 540 can send a theme to the user of mobile phone 510 via messages. Please note that if the mobile phone 540 has the hardware/software configuration of the communications device shown in FIG. 1, the user of mobile phone 540 can also receive a theme from the user of mobile phone 510 via messages. Since the detail of how an SMS message travels among the various devices of FIG. 5 is well known, further description is omitted for brevity. In fact, utilizing the present invention, any combination of devices shown in FIG. 5 can send and receive themes via SMS messages. All of these combinations obey the spirit of the present invention.

For example, the user of the mobile phone 510 might desire a new theme for the mobile phone 510. The user can utilize the computer 500 to access the web site on the web server 550 by way of the communications network 520. After a desired theme is selected from the web site, the web server 550 is capable of encoding the selected theme attributes into an SMS message that is compliant with the theme header described earlier. The web server 550 sends the SMS message to the mobile device 510 by way of the messaging service/Internet link provided by the communications network 520. Please note the Internet and cell network connecting is well known and not the focus of the present invention therefore details are omitted. The theme downloaded from the web server 550 can be sent in more than just the SMS format. Utilizing LMS or USSD also obey the spirit of the present invention. Finally, the SMS theme message will arrive at the mobile device 510 having utilized a mobile phone number that was provided to the web server 550 by the user. In summary, the downloaded theme has been encoded using theme headers and then delivered to the desired mobile device by sending the theme headers via one or more SMS message segments. The user of the mobile phone 510 is now able to select the new theme for use on their mobile phone 510. Perhaps after some modification to the new theme, (A phone user cannot make changes to the theme by just using device. He might have to send the theme to a desktop using IRDA or any other mechanism and then change. Generally, the functionality of editing a theme on the device is not in the scope of this invention. The user can send that modified theme back to the web server 550 for storage, backup, or sharing purpose.

Moreover, a user can create, modify, store, and transmit themes using theme editor software running on the computer. Due to the low computing power offered by many of the communication devices and low end mobile phones it is preferable to provide this facility for theme management utilizing an application on a personal computer. For example, the computer 500 of FIG. 5 can execute the theme editor program that allows the user to build a custom theme from the variety of available UI attributes. The theme editor software can provide only the correct UI attributes based on the user's brand and model of mobile phone. The theme editor can preview the theme for the user. Later, a complete theme can be sent from the computer 500 to any of the other devices shown in FIG. 5 utilizing the technique disclosed in the present invention.

Therefore, the present invention extends the feature of downloadable themes to a category of low-end devices, even black and white devices or devices with very limited memory and processing power, which are unable to enjoy this benefit given prior art technology.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for obtaining a user interface setting in a communication device, comprising:
receiving messages at the communication device under a message service protocol over a communication network;
among the received messages, detecting whether there is at least one message containing an identifier indicating that the at least one message containing setting data; and
storing the setting data from the at least one message into one user interface setting of the communication device so that the communication device is operative to provide a user interface according to said one user interface setting.

2. The method of claim 1, wherein the message service protocol is originally designed for providing text information to users of the communication device under a normal processing procedure, and if one received message is found not containing the identifier, the one received message is passed to the normal processing procedure.

3. The method of claim 2, wherein the message service protocol is compatible with short message service (SMS) of GSM standard.

4. The method of claim 1, wherein the message service protocol is compatible with unstructured supplementary service data (USSD).

5. The method of claim 1, wherein the at least one message contains a header portion for storing the identifier and a data portion for storing the setting data.

6. The method of claim 1, further comprising:
combining the setting data from a plurality of the received messages that have the identifiers to be stored as said one user interface setting.

7. The method of claim 1, wherein the user interface setting is a theme configuration of the communication device.

8. The method of claim 1, wherein the user interface setting contains at least one visual setting.

9. The method of claim 1, wherein the user interface setting contains at least one audio setting.

10. A method for transmitting a user interface setting to a communication device, the method comprising:
packaging setting data and an identifier of the user interface into at least one message of a message service protocol that is originally designed for transmitting text information to be displayed on the communication device; and
transmitting the at least one message to the communication device under the message service protocol over a communication network.

11. The method of claim 10, wherein the messaging service protocol is compatible with short message service (SMS) of GSM standard.

12. The method of claim 10, wherein the messaging service protocol is compatible with an unstructured supplementary service date (USSD) service.

13. The method of claim 10, wherein the user interface setting is a theme configuration of the communication device.

14. A communication apparatus supporting a message service protocol that is originally designed for text information transmission, the communication apparatus comprising:
a receiver module for receiving messages under the message service protocol over a communication network;
a parsing module for detecting among the received messages whether there is at least one message containing an identifier indicating that the at least one message containing setting data; and
a processor module for providing a user interface according to the setting data.

15. The communication apparatus of claim 14, wherein the parsing module performs a normal processing procedure on one received message for displaying associated text information if the one received message is found not containing the identifier.

16. The communication apparatus of claim 14, wherein the message service protocol is compatible with short message service (SMS) in GSM standard.

17. The communication apparatus of claim 14, wherein the message service protocol is compatible with unstructured supplementary service data (USSD).

18. The communication apparatus of claim 14, wherein the at least one message contains a header portion for storing the identifier and a data portion for storing the setting data.

19. The communication apparatus of claim 14, wherein the parsing module combines the setting data from a plurality of the received messages that have the identifiers to be stored as settings of the user interface.

20. The communication apparatus of claim 14, wherein the setting data are used for generating theme configuration of the communication apparatus.

21. The communication apparatus of claim 14, wherein the communication apparatus is a mobile phone.
